(19) United States
(12) Patent Application Publication
(10) Pub. No.: US 2026/0104107 A1
(43) Pub. Date: Apr. 16, 2026

(54) METHOD AND DEVICE

(71) Applicant: Liebherr-Aerospace Lindenberg GmbH, Lindenberg (DE)

(72) Inventors: Martin DÖHRING, Lindenberg (DE); Daniel ZIMMERMANN, Wangen (DE)

(21) Appl. No.: 19/358,010

(22) Filed: Oct. 14, 2025

(30) Foreign Application Priority Data
Oct. 14, 2024 (DE) 10 2024 129 722.0

(51) Int. Cl. F16K 37/00; F16K 31/06

(52) U.S. Cl. CPC F16K 37/0083; F16K 31/0675

(57) ABSTRACT

The present disclosure relates to a method for setting a valve, wherein setting of a property of the valve and testing of a function of the valve takes place, wherein the setting and the testing take place in an automated manner. The property of the valve may be magnetization of one or more components, for example magnets, of the valve, and/or the function of the valve is a behavior of the valve according to a characteristic based on the magnetization.

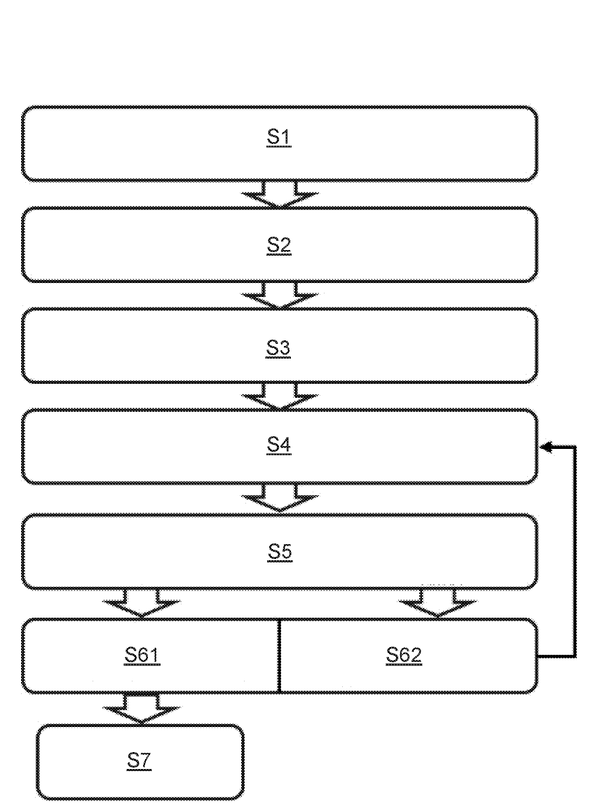

### CROSS REFERENCE TO RELATED APPLICATIONS

The present application claims priority to German Patent Application No. 10 2024 129 722.0 filed on Oct. 14, 2024. The entire contents of the above-listed application are hereby incorporated by reference for all purposes.

### TECHNICAL FIELD

The present disclosure relates to a method for setting a valve, wherein setting of a property of the valve and testing of a function of the valve takes place.

### BACKGROUND AND SUMMARY

It is known according to the prior art to magnetize one or more magnets of an electrohydraulic servo valve (EHSV) in such a way that the EHSV thus has the function that in the case of actuation of coils of the EHSV a corresponding flow through the EHSV is set.

It is known that the magnetization of the magnet or the magnets takes place such that a magnetizing device is placed on the EHSV by hand, in order to set the magnet or the magnets of the EHSV to an empirical value.

Subsequently, the behavior of the EHSV is tested or checked by means of a hydraulic test bench.

If the behavior of the EHSV does not comply with the requirements placed on the EHSV, the magnetizing device is again placed on the EHSV manually, and the magnetization is adjusted. For this purpose, the value to which the magnet or the magnets are set is set by setting a magnetization strength manually on the magnetizing device.

This procedure is repeated for as long until the function of the EHSV meets the requirements.

A disadvantage of the prior art is in particular that a plurality of steps take place manually. In particular the setting of the magnetizing device, the placing of the magnetizing device or the magnetizing head of the magnetizing device on the EHSV, and the testing or checking of the behavior by means of the hydraulic test bench are each carried out manually, at least by manually starting the test bench.

Against this background, the object of the present disclosure is to improve an above-mentioned method, in particular in view of the reduction of manual activities.

This object is achieved by the method having the features as described herein.

According thereto it is provided according to the disclosure for the setting and the testing to take place in an automated manner.

The function of the valve may be based at least in part on the property of the valve.

An automatic and/or automated magnetization of an EHSV may take place.

The entire method can take place in a partially automated manner, i.e. for example having at least one manual activity, or in a fully automated manner, i.e. for example without a manual activity. Optionally a completely automated sequence of the method takes place.

Optionally at least the setting and the testing take place in a fully automated manner.

The function of the valve may be a flow rate through the valve depending on an actuation of the valve. The function can thus be a behavior of the valve on the basis of a characteristic. In other words, the characteristic of the valve can be set in an automated manner.

It is optionally provided that the property of the valve is a magnetization of one or more components, for example magnets, of the valve, and/or the function of the valve is a behavior of the valve according to a characteristic based on the magnetization.

Automated magnetization and automated adjustment of the magnet strength of one or more magnets of the valve optionally takes place.

It may be provided that the setting and the testing are performed once or repeated iteratively until the valve exhibits the function.

The setting and the testing optionally take place automatically, one after the other, for as long until the valve exhibits the function, for example with predetermined tolerances.

It may be provided that the valve is arranged automatically and/or in an automated manner or manually in a device, for example a test bench, before the setting and the testing.

It may be provided that before the setting and the testing a setting device, for example a magnetizing device, is arranged on the valve automatically and/or in an automated manner in such a way in order to set the property, for example magnetization, of one or more components of the valve, optionally wherein the setting device is removed from the valve automatically and/or in an automated manner after completed testing.

The setting device can be a magnetizing device.

The setting optionally takes place automatically by the setting device, for example after arrangement of the setting device on the valve and/or in an automated manner.

An automated supply or delivery of the setting device optionally takes place.

It may be provided that a first setting of the property takes place with one or more empirical values.

It may be provided that a setting of the property that follows the first setting takes place automatically on the basis of one or more empirical values and/or with values determined on the basis of a first testing or testing of the function that follows the first testing.

It may be provided that after the setting and testing further settings of one or more other properties of the valve take place automatically and/or in an automated manner, and/or further testing of one or more other functions of the valve takes place in an automated manner.

It may be provided that the valve is an electrohydraulic servo valve (EHSV). The EHSV may be arranged within an aircraft, for example within a hydraulic system of the aircraft. In some example, the aircraft may be an airplane.

In one embodiment of the disclosure this also applies for all other servo valves.

The disclosure also relates to a device comprising means which are configured for carrying out a method according to the disclosure. For example, the device may comprise at least one processor and a memory storing instructions, which, when executed by the processor, cause the device to carry out the method steps described herein.

The device can be a test bench and/or comprise the setting device.

The device and/or the setting device may be automated. As a result, the complete magnetization and the testing for the function of the valve can be carried out in an automated manner.

The setting device is optionally supplied in an automated manner and sets the values required for the setting, for example magnetization, in an autonomous manner. Subsequently, testing of the function is carried out in an automated manner by a test bench. It may be provided that if the requirements for the function of the valve, for example if the parameters and/or characteristic of the valve, are not in the required range upon the testing, the setting device automatically sets new values required for setting, for example magnetization, and magnetizes the valve or one of the plurality of magnets of the valve again with or to these values. Subsequently, testing of the function is optionally carried out again by the test bench. The setting and testing is optionally repeated for as long until the function of the valve meets the requirements or the valve exhibits the desired function.

Optionally, the setting device is delivered automatically and the magnet or the magnets of the valve are magnetized to an empirical value. For example, the setting device is arranged relative to the valve in such a way that a magnetization of the magnet or the magnets of the valve can take place.

Optionally, the testing or the checking of the function of the valve by the test bench are carried out in an automated manner and/or automatically after the setting.

If the valve does not exhibit the desired function or the desired behavior, the setting or magnetization can optionally be adjusted automatically and the testing or the checking can optionally be carried out again.

Advantageously, a reduction of manual activities, a reduction of physical stresses, and/or an increase in the process reliability or safety can take place. Advantageously, a reduced cycle time for the setting of the valve can be achieved.

At this point, it is noted that the terms “a” and “an” do not necessarily refer to exactly one of the elements, even if this is a possible embodiment, but rather can also denote a plurality of the elements. Likewise, the use of the plural also includes the presence of the element in question in the singular, and, vice versa, the singular also includes a plurality of the elements in question. Furthermore, all the features of the disclosure described herein can be combined with one another as desired or claimed in isolation from one another.

### BRIEF DESCRIPTION OF THE FIGURE

Further advantages, features and effects of the present disclosure emerge from the following description of embodiments with reference to the figure. In this case, the single:

The Figure: is a schematic flowchart of an embodiment of a method according to the disclosure.

### DETAILED DESCRIPTION

The embodiment of the Figure relates to an automated setting of a characteristic of a valve in the form of an EHSV.

In this case, the EHSV is arranged in a device in the form of a test bench.

In step S1, the setting of the characteristic by the test bench is started automatically or manually.

The test bench comprises a setting device in the form of a magnetizing device.

In step S2, the magnetizing device is positioned automatically and/or in an automated manner relative to the EHSV, such that a magnetization of the magnets of the EHSV can take place.

In step S3, the magnets are magnetized automatically and/or in an automated manner using an empirical value.

In step S4, a function of the EHSV is tested automatically and/or in an automated manner. A test is performed as to whether the EHSV exhibits a desired function or a desired behavior based on a desired characteristic.

In step S5, a decision is made as to whether or not the EHSV exhibits the desired function. If the EHSV exhibits the desired function, step S61 the magnetizing device is removed from the EHSV automatically and/or in an automated manner, and the next test point of the test bench is started.

If the EHSV does not exhibit the desired function, in step S62 the settings of the magnetizing device are adjusted automatically and/or in an automated manner, in order to magnetize the magnets of the EHSV with a different value or different values, and a magnetization of the magnets of the EHSV with a different value or different values takes place. Then testing or checking of the function of the EHSV takes place again, automatically and/or in an automated manner, with step S4. The steps S62, S4 and S5 are repeated for as long until the EHSV exhibits the desired function.

Within the meaning of the disclosure, the term “automatic(ally)” has the meaning that a step or a sequence takes place autonomously without direct human intervention.

Within the meaning of the disclosure, the term “in an automated manner” has the meaning that a step or a sequence is carried out at least in part by one or more means without manual activity, wherein for example a command for starting the step or sequence can be traced back directly or indirectly to human intervention. A manual activity may be a technical activity.

1. A method for setting a valve, wherein setting of a property of the valve and testing of a function of the valve takes place, wherein the setting and the testing take place in an automated manner.

2. The method according to claim 1, wherein the property of the valve is a magnetization of one or more components of the valve, and/or the function of the valve is a behavior of the valve according to a characteristic based on the magnetization.

3. The method according to either claim 1, wherein the setting and the testing are performed once or repeated iteratively until the valve exhibits the function.

4. The method according to claim 1, wherein the valve is arranged automatically and/or in an automated manner or manually in a device before the setting and the testing.

5. The method according to claim 1, wherein before the setting and the testing a setting deviceis arranged on the valve automatically and/or in an automated manner in such a way in order to set the property of one or more components of the valve.

6. The method according to claim 1, wherein a first setting of the property takes place with one or more empirical values.

7. The method according to claim 6, wherein a setting of the property that follows the first setting takes place automatically on the basis of one or more empirical values and/or with values determined on the basis of a first testing or testing of the function that follows the first testing.

8. The method according to claim 1, wherein after the setting and testing further settings of one or more other properties of the valve take place automatically and/or in an automated manner, and/or further testing of one or more other functions of the valve takes place in an automated manner.

9. The method according to claim 1, wherein the valve is an electrohydraulic servo valve (EHSV).

10. A device, comprising means which are configured for carrying out the method according to claim 1.

11. The method according to claim 2, wherein the one or more components are magnets.

12. The method according to claim 4, wherein the device is a test bench.

13. The method according to claim 5, wherein the setting device is a magnetizing device and wherein the property of the one or more components of the valve is magnetization.

14. The method according to claim 5, wherein the setting device is removed from the valve automatically and/or in an automated manner after completed testing.

15. The method according to claim 9, wherein the EHSV is arranged within an aircraft.

16. The method according to claim 15, wherein the aircraft is an airplane.
